(19) United States
(12) Patent Application Publication
(10) Pub. No.: US 2016/0059514 A1
(43) Pub. Date: Mar. 3, 2016

(54) PLASTIC FILM LAMINATE

(71) Applicant: MONDI Consumer Packaging Technologies GmbH, Gronau (DE)

(72) Inventor: Matthias PERICK, Ahaus-Alstaette (DE)

(21) Appl. No.: 14/809,738

(22) Filed: Jul. 27, 2015

(30) Foreign Application Priority Data
Sep. 2, 2014 (EP) 14183261.8

(51) Int. Cl. B32B 5/18; B32B 27/32; B32B 27/36; B32B 27/08

(52) U.S. Cl. CPC B32B 5/18; B32B 27/08; B32B 27/32; B32B 27/36; B32B 2266/025; B32B 2553/00

(57) ABSTRACT

A plastic film laminate with a thickness between 20 μm and 250 μm has a foamed core layer, a first unfoamed outer layer with a thickness of less than 70 μm, and a second unfoamed outer layer with a thickness of less than 70 μm, and a matte surface with a reflectometer value according to DIN 67530 of less than 40 at a measurement angle of 85°. The reflectometer value determined in this way is below 30 and particularly between 10 and 25.

### FIELD OF THE INVENTION

The present invention relates to a plastic laminate. More particularly this invention concerns a plastic laminate with a foam layer.

### BACKGROUND OF THE INVENTION

A typical such multilayer film laminate is a sandwich with a thickness between 20 μm and 250 μm and formed by a foamed core layer, a first unfoamed, preferably thermally weldable outer layer and a second unfoamed outer layer with a thickness of less than 70 μm.

Such a plastic film laminate has various applications, the second unfoamed outer layer being intended to be visible to a user. One typical application for the plastic film laminate according to the invention is the manufacture of package, the second outer layer being visible on the outside of the package and the first unfoamed outer layer being on the inside. If the first unfoamed outer layer is then weldable according to one preferred embodiment, a package can be shaped especially easily through heat-sealing, with either a film blank or an endless web being shaped by folding into a package or at least two film blanks or two film webs being connected by welds.

Another application, in which the optical characteristics of the second outer layer are critical, is the manufacture of film labels, where the first unfoamed outer layer on the interior is weldable (for sleeve labels, for example) or have good adhesive qualities (for adhesive labels). As will also be explained in detail below, the plastic film laminate has special specific advantages due to the foamed core layer, for which reason the plastic film laminate is also worthy of consideration as a surface protection film, for the formation of adhesive tapes or as a kind of paper replacement.

As regards the use of the plastic film laminate for package purposes, it can be used both in a so-called FFS method (Form Fill and Seal), in which a bag-shaped package is formed immediately during package of the filled product, and in the manufacture of prefabricated package that is then filled subsequently.

Moreover, the plastic film laminate can also be used as a cover film, for example.

The core layer is has multiple purposes. First, foaming results in less weight per unit area with respect to the resulting thickness of the film, thus saving material. Particularly in combination with other unfoamed film layers, foaming generally also results in an improvement of the mechanical characteristics with respect to the quantity of plastic used due to the greater thickness. For example, if a foamed core layer is combined according to the prior art with unfoamed cover layers, it results in a kind of plywood effect in which the outer layers are separated farther apart as a result of the increase in the volume of the core layer compared to an unfoamed embodiment and deform less easily against each other. Moreover, as a result of the foaming of at least one film layer, the other physical characteristics of the resulting coextruded film are also influenced.

According to CA 1,145,724 (U.S. Pat. No. 4,267,960), EP 0 512 740 (U.S. Pat. No. 6,228,446), JP 2004-091024, EP 1,761,437 (US 2006/0003121), JP 2007-230637 and DE 10 2011 051 193 (U.S. Pat. No. 8,741,405), a foamed film layer is used as a mechanical buffer in order to increase the puncture resistance or to compensate for mechanical deformations at least partly caused by the filled product.

At least one foamed film layer can also be used for thermal isolation. Commensurate approaches are known from JP 2001-130586, U.S. Pat. No. 6,913,389, KR 2004-0005806 and KR 2004-0007381.

Moreover, a foamed film layer can also bring about a weakening in a film a promotes tearing in a desired manner. As a result of the lower density and the empty cells in the at least one foamed film layer, it can be torn with relative ease in its direction of thickness. Depending on the specific embodiment, foaming can also facilitate layer separation from an adjacent film layer, and these characteristics can be exploited for the manufacture of a tear-open package. Moreover, also in the case of a tearing of the film perpendicular to its thickness, particularly in the case of tear propagation along the direction of production, the foaming results in weakening. Depending on the manufacturing process, pronounced anisotropy can also be attributed to the fact that the pores or cells formed during foaming are aligned in a production direction, so that tearing can occur especially easily along the longitudinal direction of these cells or pores (i.e. along the production direction). The use of foamed film layers for establishing defined tearing characteristics is described, for example, in GB 2 110 215, U.S. Pat. No. 4,762,230, U.S. Pat. No. 4,781,294, EP 0,673,756 (U.S. Pat. No. 5,654,082), JP 3823967 (JP 2004091052) and DE 20 2005 002 615.

The foaming of at least one film layer also leads to increased roughness or rippling of the film surface, this effect being exploited as an advantage according to DE 2,038,557, DE 37 22 139, DE 196 53 608, JP 2001-055242 and EP 1,237,751. However, the rippling or roughness of the surface resulting from the foaming is also undesirable in many cases, such as when an appearance is being pursued that is as uniform, smooth and as high-quality as possible.

Another effect of a foamed film layer that is known from practice is that the corresponding film has greater turbidity and opacity. For example, for the provision of a non-transparent or only translucent film, the use of colored particles can also be reduced by foaming. Increasing the opacity and the use of this effect are described in EP 83 167 B1.

Various methods are known for the manufacture of films with at least one foamed film layer. The foaming can particularly be the result of a chemical reaction or a physical process. During extrusion, for example, substances contained in the polymer melt can evaporate or react to form a gas. In this context, it is also possible to introduce microspheres into the polymer melt having a propellant within a fusible shell.

In physical foaming, a propellant is added to the molten plastic mass in the extruder under high pressure. Some examples of suitable propellants are water, nitrogen or carbon dioxide.

Particularly uniform, good mechanical characteristics are achieved if the foamed layer has an especially fine-celled foam structure that can be formed, for example, by the so-called MuCell method. Devices for carrying out the method and for retrofitting standard extruders are sold by Drexel Inc., USA. The MuCell method is described in detail in U.S. Pat. No. 5,866,053, U.S. Pat. No. 6,051,174, EP 0,923,443 (U.S. Pat. No. 6,884,377), EP 1,275,485, EP 0,377,650 (U.S. Pat. No. 5,160,674), EP 0,580,777 (U.S. Pat. No. 5,334,356), U.S. Pat. No. 6,231,942, EP 0,996,536, EP 1,040,158 (U.S. Pat. No. 6,376,059), EP 1,131,387 (U.S. Pat. No. 6,613,811), EP 1,283,767 (U.S. Pat. No. 6,593,384), EP 1,337,387 (U.S. Pat. No. 6,616,434), EP 1,539,868 (US 2004/0115418), and EP 1,575,763 (U.S. Pat. No. 8,162,647). The present invention relates particularly to polyethylene coextruded films in which the foamed core layer is formed according to the described MuCell method.

A propellant is added to the melt for the core layer to be foamed during extrusion that causes foaming during extrusion and immediately after emerging from the extrusion slit nozzle. The propellant added previously to the melt under pressure undergoes a sudden decompression upon exiting from the nozzle gap of the coextrusion nozzle. The propellant is usually present within the extruder as a supercritical fluid that combines the incompressibility of a fluid with the dissolution characteristics of a gas. The propellant goes into solution in the polymer melt and forms, distributed therein, a single-phase system with the plastic melt. Through a rapid drop in pressure upon exiting from the extrusion nozzle, nucleation seeds form in the polymer melt. The gas dissolves out of the melt, and a very fine, uniform foam structure is formed. Particles in the core layer can promote the formation of an especially large quantity of small nucleation seeds. With the invention, the particles thus do not serve as a favorable volume material, or do not do so exclusively; rather, they are also used as a functional component for improving the film characteristics, namely for the formation of an especially large quantity of small voids or cells. Nonetheless, the particles can also be referred to as nucleating agents.

In order to enable the formation of cells or pores that are as uniform and fine as possible, it has proven expedient to maintain the solubility pressure in the melt at a high level as long as possible in order to then achieve a sudden drop in pressure only immediately upon exiting of the melt from the extrusion nozzle.

Additional methods for the manufacture of a film or of a plastic body with at least one foamed are also known from U.S. Pat. No. 4,473,665, U.S. Pat. No. 4,522,675, EP 580 777 (U.S. Pat. No. 5,158,986), EP 0,843,246 B1, TW 384271, U.S. Pat. No. 6,403,663 B1, EP 1,189,978, U.S. Pat. No. 7,341,683, EP 1,857,501 (US 2009/0029143) and EP 1,888,676.

Various extrusion devices are the subject matter of EP 1 075 921 (US2004/0213983) and EP 1,719,600.

Printed publications U.S. Pat. No. 4,533,578, U.S. Pat. No. 4,657,811, EP 0,237,977 (U.S. Pat. No. 4,856,656), U.S. Pat. No. 5,000,992, EP 0,553,522 (U.S. Pat. No. 5,215,691), JP 11079192, U.S. Pat. No. 6,096,793, EP 1,088,022 (U.S. Pat. No. 6,114,025), JP 2002-154555, EP 1,297,067 (US 2003/0216518), EP 1,646,677 (US 2008/0138593), JP 2006-027185, JP 2007-045047 A, JP 2007-045046, EP 1,857,501 (See above), EP 1,973,733 (US 2009/0011219), EP 2,043,857 (U.S. Pat. No. 7,993,739), WO 2008/100501 A2, WO 2009/155326, EP 2,258,545, JP 2013-111811, EP 2,668,036 (US 2013/0280517), KR 2013-0100597 A and WO 2013/179947 A1 relate to other films or other plastic objects with a foamed or the manufacture thereof.

As explained above, the present invention specifically relates to a plastic film laminate with a thickness between 20 μm and 250 μm comprising a foamed core layer, a first unfoamed, preferably weldable outer layer and a second unfoamed outer layer having a thickness of less than 70 μm. The plastic film laminate or at least a portion of the layers of the plastic film laminate can particularly be produced using the above-described MuCell method, with blown-film extrusion being preferred for simple, cost-effective production.

In known plastic film laminates with the features described above, the foamed core layer results in the disadvantage that the outer layers and particularly the usually visible second outer layer is uneven due to the underlying core layer with bubble-like cells and pores, thus impairing the visual appearance. This results in a non-uniform structure for the observer that is reminiscent of an orange.

The person skilled in the art is familiar with various measures for reducing the unevenness on the second unfoamed outer layer. For example, if the second unfoamed outer layer is very thick, the unevenness telegraphed through from the core layer lying beneath it can be leveled out to a certain extent, although the manufacturing costs and the weight per unit area of the plastic film laminate rise disadvantageously. In principle, it can also be considered to smooth second outer layer directly during its manufacture by suitable means, so that the rippling brought about by the core layer is compensated for by a variable layer thickness of the second outer layer. For example, if the entire plastic film laminate is manufactured with the core layer, the first unfoamed outer layer and the second unfoamed outer layer in a coextrusion process, the still-molten film can be introduced for the purpose of smoothing into a gap between two rollers or between a roller and a smoothing belt. The smoothing belt can enclose the associated roller over a larger angular range, so that the film guided between them is supported over a commensurately larger area, thus enabling a smooth surface to be achieved thereon in the gap upon solidification of the two outer layers. However, such a method is relatively elaborate and can only be combined with cast extrusion. Nor is the provision of an internal imprint possible in the case of a fully coextruded film.

Similar limitations apply if it is not the entire plastic film laminate that is being coextruded, but rather the second unfoamed outer layer is being subsequently extruded on and then smoothed in the molten-liquid state.

### OBJECTS OF THE INVENTION

It is therefore an object of the present invention to provide an improved plastic film laminate.

Another object is the provision of such an improved plastic film laminate that overcomes the above-given disadvantages, in particular that is easy to manufacture and is characterized by a uniform appearance.

### SUMMARY OF THE INVENTION

A plastic film laminate with a thickness between 20 μm and 250 μm has according to the invention a foamed core layer, a first unfoamed outer layer with a thickness of less than 70 μm, and a second unfoamed outer layer with a thickness of less than 70 μm, and a matte surface with a reflectometer value according to DIN 67530 of less than 40 at a measurement angle of 85°. Preferably, the reflectometer value determined in this way is below 30 and particularly between 10 and 25.

In this context, the present invention is based on the discovery that the rippling still present on the second outer layer in the plastic film laminate according to the invention is surprisingly no longer visible for a user due to the structure of the foamed core layer under it if the plastic film laminate on the second outer layer is very matte. Even if these measures do not reduce the actual unevenness at all or only to an unsubstantial extent, the rippling is no longer visible by virtue of the diffuse light refraction. Astonishingly, this applies particularly to a structure resulting from foaming and that would give a user the impression of uneven waves or dents if the surface is glossy.

For matte surfaces, the reflectometer value at a measurement angle of 85° is usually used for comparison, although the matte characteristics are also visible at the measurement angles of 60° and 20° suggested according to DIN 67530. The reflectometer value according to DIN 67530 of the plastic film laminate according to the invention is usually less than 30 at a measurement angle of 60°, preferably less than 20 and particularly between 5 and 15. At a measurement angle of 20°, the reflectometer value is usually less than 10, preferably less than 5 and particularly between 1 and 3.

With the invention, there are various possibilities for achieving the indicated visual characteristics on the surface of the second outer layer. For instance, the foamed core layer can be completely coextruded together with the first unfoamed outer layer and the second unfoamed outer layer, where a commensurately matte plastic material must then already be provided in this coextrusion process for the second outer layer. In such an embodiment, printing can only be performed subsequently on the two outer layers of the plastic film laminate formed in this manner. Since the plastic film laminate is already inherently opaque independently of the addition of colored particles due to the foaming of the core layer, such printing is preferably performed on the second outer layer. At least if the imprint extends over larger areas, a matte printing ink should be used, since the existing wave structure will otherwise become visible to a user again on the printed surfaces.

Alternatively, the second outer layer can also be provided with a coating, for example a thin matte paint, in order to achieve the reflectometer value according to the invention.

According to a preferred embodiment of the invention, the plastic film laminate is formed by a laminated composite, a film comprising the core layer on the one hand and a film comprising the second outer layer on the other hand being laminated together, preferably by an adhesive. Especially preferably, the core layer is coextruded with the first outer layer and opposite the first outer layer with an intermediate layer, the coextruded film formed in this way being laminated on the intermediate layer with a cover film and comprises at least the second outer layer. In particular, the cover film can also be a monofilm, so that it exclusively comprises the second outer layer.

If the plastic film laminate is formed as a laminated composite, an interior imprint can also be applied in an especially advantageous manner that is then optimally protected. Since this imprint is then arranged beneath the hard surface of the second outer layer, no special requirements apply to such a printing ink in terms of quality and wear resistance.

Furthermore, there is also the possibility with a laminated composite for one of the at least two interconnected films to be oriented. In the manufacture of films, orientation is understood as a stretching of the film after cooling of the polymer, whereby the polymer chains are aligned. Since the plastic is no longer molten during orientation, the chains are also no longer able to realign after the expansion and remain in a lengthened state corresponding to the ratio of expansion.

The second outer layer can preferably contain polypropylene (PP) or polyester, particularly polyethylene terephthalate (PET), as the main component. In relation to such an embodiment, the second outer layer thus contains at least 50% PP or PET by weight. Particularly, the second outer layer can consist completely of polypropylene or polyethylene terephthalate—except for the usual fillers and additives, processing agents or the like.

The above-mentioned materials are suitable both for coextrusion together with the foamed core layer and the first outer layer and for the formation of a separate cover film.

If polypropylene is used for the formation of a separate cover film, a biaxial orientation (BOPP) is especially preferred for improving the mechanical and optical characteristics.

As explained above, a certain irregularity is present on the surface of the second outer layer as a result of the underlying foamed core layer that is not visible, however, by virtue of the matte design. With regard to the characterization of surfaces, it should be pointed out that this irregularity is relatively large-scale or “long-waved,” thus resulting in the above described appearance of an orange peel for the observer. In this regard, the irregularity of the foamed core layer does not lead to increased roughness in the plastic sense, but to a ripple.

In characterizing surface quality, the terms “roughness” and “ripple” are differentiated according to DIN EN ISO 4287. Preferably, the second outer layer has an average ripple of Wₐ according to DIN EN ISO 4287 of greater than 2 μm, particularly greater than 4 μm. The average ripple Wₐ is the arithmetic mean of the profile ordinates after the short-waved portion (the roughness) has been calculated out on a cross section through the surface profile using an appropriate filter. Accordingly, the surface of the second outer layer is substantially uneven according to the indicated average ripple, although this unevenness does not become visible by virtue of the matte design according to the invention.

In this connection, it should also be considered that the cross-sectional structure differs to a certain extent in the direction of production and transversely to, because the cells or pores of the core layer created by foaming are usually elongated in the direction of production. A greater wavelength can therefore be associated with the unevenness in a section along the direction of production than in the transverse direction, so that a stripe structure that is objectionable from the user's perspective can also be produced on the second outer layer in the case of a glossy surface. Through the matte design according to the invention, even such inherently present stripe-like structures are no longer visible. Preferably, the space between a wave trough and an adjacent wave peak of a cross-sectional profile is between 0.1 and 5 mm in the wave structure both in the direction of production and transversely thereto, i.e. in any section, the height difference between wave trough and wave peak typically are between 4 μm and 20 μm.

As explained above, the second outer layer can be thin because it is intended to visually conceal the wavy structure by means of the matte design and not compensate for it in the manner of a buffer of variable thickness. The thickness of the second unfoamed outer layer is preferably between 15 and 40 μm and is constant and uniform.

The core layer and the first outer layer can particularly be formed on the basis of polyethylene as the main component. If the plastic film laminate is laminated from a coextruded film and a cover film, the coextruded film preferably has three layers, and the foamed core layer is between the first outer layer and an intermediate layer in the coextruded film, the intermediate layer forming a surface in of the coextruded film alone on which the cover film formed by the second outer layer is subsequently bonded. It has been found that, through appropriate measures, the ripple can still be kept relatively low in such a three-layered construction of the coextruded film, thus resulting in especially advantageous optical characteristics in connection with the matte design of the second outer layer. Starting from the described three-layered design of the coextruded film, the core layer has a polyethylene or a polyethylene-based mixture as the polymer component having a melt flow rate (MFR) according to DIN EN ISO 1133 of greater than 5 g/10 min at 190° C. and 2.16 kg.

The melt mass flow rate (MFR) is used to characterize the flow behavior of a thermoplastic plastic under predetermined pressure and temperature conditions. The melt mass flow rate is frequently used as a comparative figure for characterizing the flow characteristics of different plastics. According to DIN ISO EN 1133, it is defined as the mass of plastic that flows in 10 min at a predetermined temperature and pressure through a capillary having specific dimensions. Usually, the viscosity of a thermoplastic plastic increases with the chain length of the polymers and with the degree of branching, whereby the melt mass flow rate decreases accordingly.

The core layer can particularly be formed from particles and the polymer component on the basis of polyethylene and, optionally, additional processing agents, usually in an amount of less than 1% by weight. According to the invention, the entire polyethylene-based polymer component has a melt mass flow rate (MFR) of greater than 6 g/10 min at 190° C. and 2.16 kg and therefore has a comparatively low viscosity. Particularly in connection with particles, very uniformly distributed small cells can form in the core layer at the indicated melt mass flow rate during manufacture after exiting from the gap of a coextrusion nozzle, the core layer—which still has a relatively low viscosity during the extrusion process after exiting from the extrusion nozzle—being arranged between the first outer layer and the intermediate layer, and an inclusion of the core layer occurs toward the outside. However, due to the high melt mass flow rate of greater than 5 g/10 min, preferably greater than 6 g/10 min, more preferably greater than 8 g/10 min and especially preferably greater than 10 g/10 min at 190° C. and 2.16 kg, relatively uniform conditions are prevalent in the entire core layer immediately after extrusion which promote especially uniform foaming.

Particularly, with the invention the first outer layer and the intermediate layer have a low level of rippling and roughness on the surfaces of the outer layers compared to known polyethylene-coextruded films with a foamed core layer.

When determining the melt mass flow rate, the entire polymer component of the core layer is used as the basis. So if the core layer has different polyethylene types, for example, the melt mass flow rate must be determined for the corresponding polymer mixture.

The particle content in the core layer is usually between 5 and 5% by weight, preferably between 10 and 30% by weight.

As described above, the first outer layer and the intermediate layer act as a kind of boundary during the coextrusion and foaming of the core layer that also build up a certain counterpressure with respect to the expansion of the core layer as well. Preferably, the first outer layer and the intermediate layer have a substantially higher viscosity and thus a substantially lower melt mass flow rate according to DIN ISO EN 1133 at 190° C. and 2.16 kg. If the first outer layer and the intermediate layer each have a polyethylene or a polyethylene-based mixture as the polymer component, the melt mass flow rate (MFR) of each of the two polymer components is preferably below 2 g/10 min, especially preferably below 1 g/10 min.

In other words, the ratio of the melt mass flow rate of the polymer component of the core layer to the melt mass flow rate of the polymer components of the first outer layer or the intermediate layer is at least 2.5, preferably at least 3 and especially preferably at least 6. With the invention, ratios of greater than 10 can also be readily achieved. As a result of such a ratio, it becomes clear that the first outer layer and the intermediate layer are substantially more viscous than the core layer. In consideration of these parameters, films with a relatively uniform, level surface were able to be formed in the framework of preliminary experiments. It is assumed that this can be attributed to the fact that, on the one hand, the first outer layer and the intermediate layer bring about increased counterpressure during the expansion of the core layer at a lower melt mass flow rate immediately during extrusion and, on the other hand, the comparatively viscous layers can be less deformed through the formation of individual cells and bubbles in the core layer. The first outer layer and the intermediate layer are thus too viscous, as it were, to be highly deformed starting from a substantially level alignment.

The first weldable outer layer and the intermediate layer can have polymer mixtures with an equal or approximately equal melt mass flow rate in order to bring about an approximately matching counterpressure during the expansion of the core layer as described above.

According to an alternative embodiment of the invention, the first, weldable outer layer has a higher melt mass flow rate than the intermediate layer. The first outer layer acting as a sealing layer is frequently arranged on the inside, because a certain slight ripple can be accepted there, whereas the intermediate layer that is on the outside should be as smooth as possible. For example, the first outer layer can have a melt mass flow rate from 2 to 3 g/10 min, while the intermediate layer has a melt mass flow rate of 1 g/10 min. When the melt mass flow rate is set up in such an asymmetrical manner, the surface of the intermediate layer can ultimately be made even smoother, since the individual cells expand in a more pronounced manner in the direction of the first outer layer during the foaming of the core layer and thus tend to lead to unevenness there instead.

As described above, the MuCell method described above is preferably used for foaming the core layer with the invention, with a microcell structure being produced in the core layer. The microcell structure is characterized by a pore structure with an average pore size of less than 100 μm, it also being possible for the pore size to lie in the range between 0.1 μm and 10 μm. Since the individual pores or cells can be aligned in a certain manner in the direction of production through the coextrusion process, the volume of the closed cells of the core layer in particular is a suitable, the volume preferably being less than 50000 μm³, preferably less than 20000 μm³ and, for example, less than 5000 μm³.

According to a preferred embodiment of the invention, if nitrogen is used as a propellant for physical foaming, the core layer has commensurately closed cells filled with nitrogen.

The degree of foaming can be adjusted by adjusting the quantity of propellant added, the viscosity of the polymer components of the core layer and of the other layers, and the extrusion conditions. Preferably, the core layer has a density between 0.2 g/cm³ and 0.8 g/cm³. The increase in the thickness of the core layer in comparison to an unfoamed layer with the same amount of polymer thus typically lies between about 20% and 500%, especially preferably between about 40% and 200%, especially preferably between 50% and 120%.

Unlike a completely unfoamed film, the plastic film laminate according to the invention is characterized by a low weight per unit area and thus by low material input, it being possible to achieve sufficient mechanical characteristics in terms of stiffness and tensile strength through an appropriate coordination of the layer thicknesses. Preferably, the thickness of the foamed core layer is between 20% and 70% of the total thickness of the entire plastic film laminate. Accordingly, the two outer layers each have a thickness that is between about 15% and 30% of the total thickness of the polyethylene-coextruded film.

The polymer component of the core layer can contain a linear polyethylene, including metallocene catalyst-derived types, as the main component. Linear polyethylenes of high (LHDPE), medium (LMDPE) and low (LLDPE) density are worthy of consideration. In principle, all known linear types of polyethylenes, i.e. polyethylene-based alpha-olefin copolymers, are worthy of consideration. Copolymers with hexene (C6) and octene (C8) are preferred.

Using the various types of linear polyethylenes described above, the mechanical characteristics can be set over a wide range. Particularly when it comes to packaging material, a low-density linear polyethylene is frequently advantageous in to avoid an excessively rigid and brittle package design.

However, a mixture is also preferred for the polymer component of the core layer and, in addition to the linear polyethylene, particularly a low-density polyethylene (LLDPE), contains at least one other low-density polyethylene. Without restriction, it can be a low-density linear polyethylene (LDPE) or a metallocene linear low-density polyethylene (mLLDPE). In the framework of these embodiments as well, linear polyethylene is provided as the main component of the polymer component of the core layer. For example, the core layer can be formed from 10 to 30% fillers by weight, including processing agents, 10 to 30% LDPE or mLLDPE by weight, and the rest from LLDPE.

Within the framework of the invention, at least one of the two outer layers or the optionally provided intermediate layer contains colored particles in order to obtain a non-transparent film overall. In so doing, the fact that the core layer is rendered turbid at least to a certain extent by the foaming can be exploited in that the proportion of colored particles can optionally be reduced compared to an unfoamed coextruded film.

### BRIEF DESCRIPTION OF THE DRAWING

The above and other objects, features, and advantages will become more readily apparent from the following description, reference being made to the accompanying drawing in which:

FIG. 1 is a coextruded plastic film laminate; and

FIG. 2 is a plastic film formed by laminating a second outer layer over a coextruded three-layer film.

### SPECIFIC DESCRIPTION OF THE INVENTION

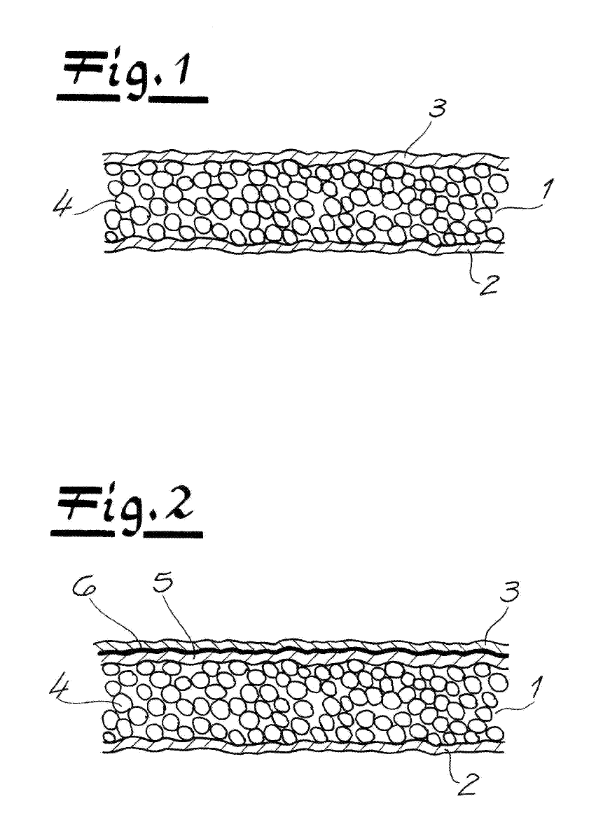

As seen in FIG. 1 a plastic film laminate has a total thickness between 20 μm and 250 μm. The plastic film laminate has a foamed core layer 1, a first unfoamed, thermally weldable outer layer 2 and a second unfoamed outer layer 3 having a thickness of less than 70 μm, typically between 15 μm and 40 μm.

The foamed core layer 1 has gas-filled cells 4, so that the core layer 1 has pronounced ripple as a result of the foaming. Since the two outer layers 2 and 3 have a uniform or at least substantially uniform thickness and are quite flexible, the ripple of the core layer 1 is also present on the surfaces of the first outer layer 2 and second outer layer 3.

According to a preferred embodiment of the invention, if the plastic film laminate is provided for the manufacture of packaging and the first outer layer 2 is then oriented to face inward into a package, the described ripple does not represent any substantial limitation. In contrast, the second outer layer 3 is visible and turned outward. In order to avoid visual impairments and the appearance of an orange peel, the surface of the second outer layer is matte with a reflectometer value according to DIN 6753 of less than 40 at a measurement angle of 85°, preferably less than 30 and particularly between 10 and 25. The existing, relatively pronounced ripple is then no longer visible to an observer as a flaw.

The structure shown in FIG. 1 is preferably formed by coextrusion, and the core layer 1 is enclosed between the first outer layer 2 and the second outer layer 3 during the extrusion process.

FIG. 2 shows a plastic film laminate in which the core layer 1 is coextruded together with the first outer layer 2 and an intermediate layer 5, a cover film then being laminated on the intermediate layer that comprises only the second outer layer as a monofilm. The lamination can be done using adhesive 6, it being possible for the intermediate layer 5 or face of the second outer layer 3 covered in the plastic film laminate to be provided an imprint before lamination that is then covered by the plastic film laminate and thus optimally protected.

I claim:

1. A plastic film laminate with a thickness between 20 μm and 250 μm, the laminate comprising:
a foamed core layer;
a first unfoamed outer layer with a thickness of less than 70 μm; and
a second unfoamed outer layer with a thickness of less than 70 μm, and a matte surface with a reflectometer value according to DIN 67530 of less than 40 at a measurement angle of 85°.

2. The plastic film laminate defined in claim 1, wherein the reflectometer value according to DIN 67530 is less than 30.

3. The plastic film laminate defined in claim 2 wherein the reflectometer value is between 10 and 25 at a measurement angle of 85°.

4. The plastic film laminate defined in claim 1 wherein the core layer is coextruded with the first outer layer and the second outer layer.

5. The plastic film laminate defined in claim 1, further comprising:
an intermediate plastic film layer coextruded with the core layer, the second layer being bonded to an outer face of the intermediate layer.

6. The plastic film laminate defined in claim 5, further comprising:
an imprint on an inner face of the intermediate layer.

7. The plastic film laminate defined in claim 5, wherein the second layer is oriented biaxially.

8. The plastic film laminate defined in claim 1, wherein the second layer is mostly made of polypropylene.

9. The plastic film laminate defined in claim 1, wherein the second layer contains polyester.

10. The plastic film laminate defined in claim 9, wherein the polyester is mostly polyethylene terephthalate.

11. The plastic film laminate defined in claim 1, wherein the second layer has an average ripple according to DIN EN ISO 4287 of greater than 2 μm.

12. The plastic film laminate defined in claim 1, wherein the second layer has a thickness between 15 μm and 40 μm.

13. The plastic film laminate defined in claim 1 wherein the core layer and the second layer are mostly polyethylene.
